(19) United States
(12) Patent Application Publication
(10) Pub. No.: US 2026/0085374 A1
(43) Pub. Date: Mar. 26, 2026

(54) JET-TYPE DIRECT-FIRED PREHEATING SYSTEM

(71) Applicant: BAOSHAN IRON & STEEL CO., LTD., Shanghai (CN)

(72) Inventors: Liyang ZHANG, Shanghai (CN); Jun LI, Shanghai (CN); Junfei WANG, Shanghai (CN); Zhaotang WAN, Shanghai (CN); Yanhui WANG, Shanghai (CN)

(73) Assignee: BAOSHAN IRON & STEEL CO., LTD., Shanghai (CN)

(21) Appl. No.: 19/110,174

(22) PCT Filed: Sep. 15, 2023
(86) PCT No.: PCT/CN2023/119085

§ 371 Date: Mar. 10, 2025

(30) Foreign Application Priority Data
Sep. 15, 2022 (CN) 202211131587.0

(51) Int. Cl. C21D 9/56; F27D 3/00; F27D 7/04; F27D 17/15; F27D 17/17; F27D 17/18; F27D 19/00; F27D 99/00

(52) U.S. Cl. CPC C21D 9/561; C21D 9/565; F27D 3/0024; F27D 7/04; F27D 17/15; F27D 17/17; F27D 17/18; F27D 19/00; F27D 99/0075; F27D 2003/0042; F27D 2007/045; F27D 2019/0021

(57) ABSTRACT

A jet-type direct-fired preheating system, comprising a direct-fired furnace and a preheating furnace. The direct-fired furnace comprises a furnace casing, a direct-fired heating area being provided in the furnace casing. The preheating furnace comprises: a furnace body, wherein the upper portion of the furnace body is connected to the upper portion of the direct-fired furnace by means of a communicating pipe, the bottom of the furnace body is provided with a strip steel inlet, a sealing apparatus and a steering roller, an upper collection chamber of direct-fired waste gas and a secondary combustion chamber of direct-fired combustion waste gas are provided at the upper portion in the furnace body, and a lower collection chamber of the direct-fired waste gas is provided at the lower portion in the furnace body; and a plurality of heat exchange and jet bellows units, provided in the furnace body in the height direction of the furnace body, a threading channel being formed in the middle. Each heat exchange and jet bellows unit comprises: a bellows body, a heat exchange pipe being provided in the bellows body, and a nozzle being provided on the side surface opposite to the threading channel; a secondary waste gas mixing chamber provided between the bellows bodies; and a circulating fan, an inlet pipeline port being formed in the threading channel, and an outlet pipeline port being located in the bellows body. According to the present invention, strip steel can be quickly preheated to 350° or above and quickly heated to 750° or above; and waste heat of the waste gas is fully utilized, such that an over-thick oxide layer can be prevented from being generated on the surface of the strip steel.

### TECHNICAL FIELD

The present disclosure relates to the technical field of continuous heat treatment of strip steel, in particular to a jet direct fire preheating system.

### BACKGROUND

Due to the advantages of high production efficiency and good surface quality of strip steel, continuous annealing has largely replaced bell annealing. The main equipment used for continuous annealing is a continuous annealing furnace. In continuous annealing furnaces, vertical annealing furnaces are the preferred annealing furnace type for large-scale continuous annealing units or hot-dip galvanizing units. Generally, the vertical annealing furnace includes a preheating section, a heating section, a soaking section, a slow cooling section, a fast cooling section and other parts. When the heating section adopts the direct fire heating section, the exhaust gas temperature of direct fire combustion can reach 1000° C. or more. In order to apply the heat of the direct fire combustion exhaust gas to the strip steel, the direct fire combustion exhaust gas is usually drained to the preheating section (the corresponding equipment is called the preheating furnace) with an exhaust gas fan. In the preheating section, the strip steel runs upward, and the direct fire combustion exhaust gas runs downward, and the direct fire combustion exhaust gas contacts with the strip steel during the operation process to preheat the strip steel. The exhaust gas after preheating the strip steel is drained out of the furnace through pipelines for secondary use (usually using a waste heat boiler to recover heat) and then discharged. This technology has the following shortcomings:
1) The emission temperature of the direct fire combustion exhaust gas after pre-heating the strip steel is still relatively high, usually exceeding 800° C., sometimes exceeding 850° C. When it exceeds 850° C., it is usually necessary to mix cold air to control the emission temperature of the exhaust gas at 850° C. or lower before it can be used for secondary offline utilization. The higher the exhaust gas temperature, the more heat energy is lost. It can be seen that in this method, the primary online utilization rate of heat energy is low, and the steam or hot water generated by the secondary offline utilization often cannot be fully consumed in the unit, so it will bring the difficulty of energy balance in the region.
2) Because the direct fire combustion exhaust gas is directly in contact with the strip steel with longer contact time and the excess gas in the direct fire combustion exhaust gas needs to undergo a secondary combustion in the preheating section wherein the secondary combustion flame is often an oxidizing flame, the increase of the preheating temperature of the strip steel will be limited inevitably. Otherwise, it is easy to form an excessively thick oxide layer on the surface of the strip steel, causing surface quality problems, and usually the preheating temperature of the strip steel can only be preheated to about 250° C., and the preheating effect is poor.
3) Under this preheating condition, the heating capacity of the corresponding direct fire heating is limited, and the heating temperature cannot be too high. Usually the strip steel can be only heated to 750° C. or lower, and the strip steel is prone to serious oxidation after further increasing the heating temperature.

### SUMMARY

One object of the present disclosure is to provide a jet direct fire preheating system, which can quickly preheat the strip steel to at least 350° C. or higher, and cooperate with the direct fire heating furnace to quickly heat the strip steel to 750° C. or higher; at the same time, the waste heat of the direct fire combustion exhaust gas is fully utilized, and the direct fire combustion exhaust gas can be prevented from directly contacting the strip steel in the preheating furnace for a long time, so as to avoid the formation of an excessively thick oxide layer on the surface of the strip steel.

In order to achieve the above purpose, the technical solution of the present disclosure is as follows:

A preheating furnace comprising:
a furnace body, which is provided with at least two connecting holes on the upper side wall, symmetrically arranged on the left and right, wherein the connecting holes connect through holes of the upper part of the furnace shell of a direct fire furnace through a communicating pipe respectively; wherein the top of the furnace body is provided with a furnace throat corresponding to a furnace top roller chamber of the direct fire furnace for passing the strip steel; the bottom of the furnace body is provided with a strip steel inlet and a corresponding sealing device and a steering roller; the upper part of the furnace body is provided with an upper partition plate with a threading hole to form an upper gas collection chamber for direct fire exhaust gas; a secondary combustion chamber for direct fire combustion exhaust gas is provided below the upper gas collection chamber for direct fire exhaust gas, and at least one open flame burner is provided in the secondary combustion chamber for direct fire combustion exhaust gas; the lower part of the furnace body is provided with a lower partition plate with a threading hole to form a lower gas collection chamber for direct fire exhaust gas, which connects an exhaust gas fan through an exhaust gas discharge pipeline;
a plurality of heat exchange and jet bellows units, which are arranged on two sides below the secondary combustion chamber for direct fire combustion exhaust gas in the furnace body along the height direction of the furnace body, wherein a threading channel for passing the strip steel, i.e., a preheating channel, is formed in the middle; wherein each heat exchanger and jet bellows unit comprises,
a bellows body, which is vertically provided with a plurality of heat exchange pipes, wherein the bellows body is provided with a plurality of nozzles on the side opposite to the threading channel; wherein an exhaust gas secondary mixing chamber that is communicated with the heat exchange pipe is provided between the bellows bodies that are arranged up and down;
a circulating fan, wherein an inlet pipeline port is arranged in the threading channel, and an outlet pipeline port is located in the bellows body;
a plurality of sealing devices that can be passed through by the strip steel are respectively arranged at the upper and lower ports of the threading channel and the threading holes of the upper and lower partition plates.

Preferably, a combustion exhaust gas thermometer is also provided in the secondary combustion chamber for direct fire combustion exhaust gas, which is used for measuring the actual temperature of the combustion exhaust gas that is about to enter the heat exchange and jet bellows unit after the secondary combustion. When the thermometer detects that the exhaust gas temperature at the top of the heat exchange and jet bellows unit is too high, the exhaust gas temperature can be reduced by adjusting the amount of combustion air of the open flame burner (the open flame burner comes with a long open flame ignition burner, and the air volume of the ignition burner does not participate in the adjustment, so as to maintain the stability of the ignition burner and ensure that the remaining gas in the exhaust gas can undergo a secondary combustion), so as to ensure the service life of the heat exchange and jet bellows unit, especially its circulating fan.

Preferably, the sealing device has a nitrogen gas sealing structure, which adopts a nitrogen gas sealing chamber with a nitrogen gas injection pipeline arranged thereon.

Preferably, the exhaust gas discharge pipeline is connected to a waste heat boiler and a chimney.

Preferably, a control valve is arranged on the exhaust gas discharge pipeline for the rapid adjustment of the exhaust gas furnace pressure, so as to keep the furnace pressure more stable.

Preferably, a shielding gas of nitrogen and hydrogen is introduced into the bellows body.

The preheating furnace of the present disclosure can be used to preheat the strip steel by utilizing the heat of the direct fire combustion exhaust gas (its temperature can reach 1000° C. or higher). In the preheating furnace, the strip steel runs upward, the direct fire combustion exhaust gas runs downward, and the direct fire combustion exhaust gas contacts with the strip steel during the operation process to preheat the strip steel. The preheating furnace of the present disclosure can be used to preheat the strip steel quickly to 350° C. or more.

In the preheating furnace of the present disclosure:

The connecting holes that are provided on the upper side wall of the furnace body are used for communicating with the through holes of the upper part of the furnace shell of the direct fire furnace, and for receiving the direct fire combustion exhaust gas;

The sealing device at the strip steel inlet arranged at the bottom of the furnace body is communicated with a nitrogen injection pipeline, and by injecting nitrogen at a certain pressure, the direct fire combustion exhaust gas entering into the threading channel can be reduced as much as possible;

The upper partition plate with a threading hole arranged in the upper part of the furnace body forms a upper gas collection chamber of direct fire exhaust gas with the upper part of the furnace body, and the upper gas collection chamber of direct fire exhaust gas is communicated with the through hole of the upper part of the furnace shell of the direct fire furnace, which is used for accommodating the direct fire combustion exhaust gas, and allows heat exchange of the exhaust gas with the strip steel;

The secondary combustion chamber for direct fire combustion exhaust gas arranged below the upper gas collection chamber for direct fire exhaust gas is used for secondary combustion of excess gas in the direct fire combustion exhaust gas from the upper gas collection chamber for direct fire exhaust gas. It is provided with at least one open flame burner, and a sealing device is arranged in the part close to the strip steel in the secondary combustion chamber of direct fire combustion exhaust gas, and the sealing device is communicated with a nitrogen injection pipeline. By the injection of nitrogen, the direct fire combustion exhaust gas entering into the threading channel can be reduced as much as possible to prevent the direct fire combustion exhaust gas from direct contacting with the strip steel. The sealing device is a nitrogen sealing chamber, and the nitrogen in the sealing chamber has a certain pressure to reduce the direct fire combustion exhaust gas entering into the threading channel as much as possible;

The lower partition plate with a threading hole arranged in the lower part of the furnace body forms a lower gas collection chamber of direct fire exhaust gas with the lower part of the furnace body, which is used for collecting the direct fire combustion exhaust gas flowing down from the upper part, and utilizes the exhaust gas to exchange heat with the strip steel. The direct fire combustion exhaust gas in the lower gas collection chamber for direct fire exhaust gas is discharged from the lower gas collection chamber for direct fire exhaust gas through the exhaust gas discharge pipeline that connects the exhaust gas fan;

The heat exchange and jet bellows unit provided in the furnace body is arranged between the secondary combustion chamber for direct fire combustion exhaust gas and the lower gas collection chamber for direct fire exhaust gas, and is arranged on both sides of the threading channel along the height direction of the furnace body. The gas outside the heat exchange pipe (usually the shielding gas of nitrogen and hydrogen) is heated by the direct fire combustion exhaust gas that goes down through the heat exchange pipe, and the heated gas is sprayed on the strip steel that passes through the threading channel through the nozzle to preheat the strip steel, and the gas injected into the threading channel is pumped out by the circulating fan and sent into the bellows body again, to undergo the heat exchange with the direct fire combustion exhaust gas;

The direct fire combustion exhaust gas that goes down through the heat exchange pipe in the bellows body enters the exhaust gas secondary mixing chamber that is arranged in the furnace body, and enters the heat exchange pipe of the lower bellows body again after mixing, to repeat the above-mentioned heat exchange process.

The present disclosure further provides a jet direct fire preheating system, which comprises: a direct fire furnace, a preheating furnace; wherein
the direct fire furnace comprises:
a furnace shell, wherein a furnace top roller chamber and a furnace bottom roller chamber are respectively provided at the upper and lower ends; steering rollers are respectively arranged in the furnace top roller chamber and the furnace bottom roller chamber; a plurality of direct fire heating zones are arranged in the furnace shell along the height direction, and a plurality of direct fire burners are arranged in the direct-fire heating zone; at least two through-holes are provided on the upper side wall of the furnace shell, and are symmetrically arranged on the left and right;
the preheating furnace comprises:
a furnace body, which is provided with at least two connecting holes on the upper side wall, symmetrically arranged on the left and right, wherein the connecting holes connect through holes of the upper part of the furnace shell of the direct fire furnace through a communicating pipe respectively; wherein the top of the furnace body is provided with a furnace throat corresponding to the furnace top roller chamber of the direct fire furnace for passing the strip steel; the bottom of the furnace body is provided with a strip steel inlet and a corresponding sealing device and a steering roller; the upper part of the furnace body is provided with an upper partition plate with a threading hole to form an upper gas collection chamber for direct fire exhaust gas; a secondary combustion chamber for direct fire combustion exhaust gas is provided below the upper gas collection chamber for direct fire exhaust gas, and at least one open flame burner is provided in the secondary combustion chamber for direct fire combustion exhaust gas; the lower part of the furnace body is provided with a lower partition plate with a threading hole to form a lower gas collection chamber for direct fire exhaust gas, which connects an exhaust gas fan through an exhaust gas discharge pipeline;
a plurality of heat exchange and jet bellows units, which are arranged on two sides below the secondary combustion chamber for direct fire combustion exhaust gas in the furnace body along the height direction of the furnace body, wherein a threading channel for passing the strip steel, i.e., a preheating channel, is formed in the middle; wherein each heat exchanger and jet bellows unit comprises,
a bellows body, which is vertically provided with a plurality of heat exchange pipes, wherein the bellows body is provided with a plurality of nozzles on the side opposite to the threading channel; wherein an exhaust gas secondary mixing chamber that is communicated with the heat exchange pipe is provided between the bellows bodies that are arranged up and down; a shielding gas of nitrogen and hydrogen is introduced into the bellows body;
a circulating fan, wherein an inlet pipeline port is arranged in the threading channel, and an outlet pipeline port is located in the bellows body;
a plurality of sealing devices that can be passed through by the strip steel are respectively arranged at the upper and lower ports of the threading channel and the threading holes of the upper and lower partition plates.

Preferably, a combustion exhaust gas thermometer is further provided in the secondary combustion chamber for direct fire combustion exhaust gas, which is used for measuring the actual temperature of the combustion exhaust gas that is about to enter the heat exchange and jet bellows unit after the secondary combustion. When the thermometer detects that the exhaust gas temperature at the top of the heat exchange and jet bellows unit is too high, the exhaust gas temperature can be reduced by adjusting the amount of combustion air of the open flame burner (the open flame burner comes with a long open flame ignition burner, and the air volume of the ignition burner does not participate in the adjustment, so as to maintain the stability of the ignition burner and ensure that the remaining gas in the exhaust gas can be undergo a secondary combustion), so as to ensure the service life of the heat exchange and jet bellows unit, especially its circulating fan.

Preferably, the sealing device has a nitrogen gas sealing structure, which adopts a nitrogen gas sealing chamber with a nitrogen gas injection pipeline arranged thereon.

Preferably, the exhaust gas discharge pipeline is connected to a waste heat boiler and a chimney.

Preferably, a control valve is arranged on the exhaust gas discharge pipeline for the rapid adjustment of the exhaust gas furnace pressure, so as to keep the furnace pressure more stable.

In the preheating system of the present disclosure:

The preheating system is provided with a heat exchange and jet bellows unit and a secondary combustion chamber for direct fire combustion exhaust gas, wherein the heat exchange and jet bellows unit adopts a heat exchange pipeline (the heat exchanger is not arranged outside the furnace), the combustion exhaust gas re-burned in the secondary combustion chamber for direct fire combustion exhaust gas is utilized to heat the shielding gas of nitrogen and hydrogen circulating in the bellows body, and the shielding gas of nitrogen and hydrogen heated under the action of circulating fan is sprayed on the upper and lower surfaces of the strip steel at high speed for forced convection and heat exchange, so as to realize fast and efficient pre-heating of the strip steel.

An open flame burner is further provided in the secondary combustion chamber for direct fire combustion exhaust gas, which is used for insufficiently burned gas in the direct fire combustion exhaust gas to undergo oxygen-rich secondary combustion in the secondary combustion chamber for the direct fire combustion exhaust gas, and the burning flame will not contact the strip steel.

The exhaust gas secondary mixing chamber that is communicated with the heat exchange pipe is arranged between the bellows bodies that are arranged up and down, and after the exhaust gas is subjected to temperature homogenization in the exhaust gas secondary mixing chamber, it enters the downward bellows body.

The sealing device has a nitrogen gas sealing structure, which is provided with a nitrogen gas sealing chamber. Nitrogen gas injection pipeline ports are arranged in the nitrogen gas sealing chamber. By injecting the sealing nitrogen gas into the nitrogen gas sealing chamber, relatively high pressure is maintained to prevent a large amount of direct fire combustion exhaust gas entering into the threading channel in the heat exchange and jet bellows unit in the furnace, thereby avoiding excessive oxidation of the strip steel surface by the direct fire combustion exhaust gas.

A sealing device is arranged at the strip steel inlet of the preheating furnace, and a gas injection port is also arranged inside the preheating furnace. A small amount of sealing nitrogen or air is sprayed, and its effect is to prevent direct fire combustion exhaust gas from overflowing out of the furnace.

During the production process, the high-temperature combustion exhaust gas produced by the direct fire combustion of the direct fire furnace enters the preheating furnace through the communicating pipe. A plurality of heat exchange and jet bellows units arranged up and down in sequence are provided in the preheating furnace, and the heat exchange pipeline of the heat exchange and jet bellows unit (high-temperature combustion exhaust gas goes through the pipe, and the shielding gas goes through the shell) heats the mixed gas of nitrogen and hydrogen in the bellows body, and the high-temperature mixed gas of nitrogen and hydrogen is sprayed to both sides of the strip steel through the high-speed nozzles facing both sides of the strip steel, so that the strip steel is quickly heated. The sprayed high-temperature mixed gas of nitrogen and hydrogen is heat exchanged with the low-temperature strip steel. After the temperature of the mixed gas is lowered, the mixed gas is pumped back to the heat exchanger in the furnace with the circulating fan arranged near to both sides of the strip steel and heat exchanged again with the combustion exhaust gas that goes through the internal pipe, so as to raise the temperature of the mixed gas of nitrogen and hydrogen again. Then it is sprayed again to both sides of the strip steel from the inside of the jet bellows unit, and so on.

Compared with the structure of the traditional direct fire preheating furnace, the advantages and beneficial effects of the present disclosure are as follows:
1. The present disclosure adds heat exchange and jet bellows units in the preheating furnace, sprays the heated shielding gas of nitrogen and hydrogen to the upper and lower surfaces of the strip steel at a high speed for forced convection and heat exchange, realizes fast and efficient preheating of the steel. Compared with the traditional preheating method, this method has advantages that the heat loss of the furnace shell and the shielding gas channel is significantly reduced, and the waste heat of the combustion direct fire exhaust gas is more fully utilized, the heating efficiency is higher, and the heating rate is faster. The direct fire exhaust gas is used to heat the gas in the jet bellows and preheat the strip steel with jet gas through the nozzle. Compared with the prior art, it further improves the preheating efficiency and the heat utilization of the direct fire exhaust gas is more sufficient.
2. The present disclosure designs heat exchange into the preheating furnace. The direct fire combustion exhaust gas mainly passes through the heat exchange and jet bellows unit in the preheating furnace, and a full heat exchange of the direct fire combustion exhaust gas with the heat exchange pipeline in the bellows is carried out in the passing process, so as to heat the shielding gas of nitrogen and hydrogen in the bellows. Therefore, the direct fire combustion exhaust gas in the preheating furnace is not in direct contact with the strip steel all the time (only in direct contact in the high-temperature section for a short time and the exhaust gas belongs to a reducing atmosphere or the slight-oxidizing atmosphere at this time), so that the excessive oxidation of the strip steel surface can be avoided.
3. The present disclosure designs a secondary combustion chamber and an open flame burner for direct fire combustion exhaust gas in the preheating furnace. The gas that is not fully combusted in the direct fire combustion exhaust gas undergoes oxygen-rich secondary combustion in the semi-sealed secondary combustion chamber for direct fire combustion exhaust gas at the top of the preheating furnace, but the combustion flame does not contact the strip steel, so the excessive oxidation of the strip steel surface is effectively avoided.
4. The present disclosure adopts preheating. The preheating temperature of the strip steel is higher, because the high-speed and high-efficiency injection of the high-temperature shielding gas of nitrogen and hydrogen has high preheating heat exchange coefficient. The temperature of the strip steel after preheating can reach 350° C. or higher, and is at least 100° C. higher than the temperature of the strip steel treated by the ordinary preheating furnace;
5. The temperature of the direct combustion exhaust gas from the preheating furnace of the present disclosure is usually much lower than 750° C. (if the number of high-speed injection preheating units is enough, it can even reach 200° C. or lower for direct discharge), and there is no need to mix with cold air for secondary use outside the furnace or do not need to be reused at all. It can be seen that the present disclosure not only realizes the full utilization of the waste heat of the direct fire furnace exhaust gas, but also avoids the excessive oxidation of the surface of the strip steel caused by the direct fire furnace exhaust gas in contact with the strip steel for too long.

### DESCRIPTION OF THE DRAWINGS

FIG. 1 is a schematic diagram of the structure of the Example of the present disclosure;

FIG. 2 is a schematic diagram of the structure of the preheating furnace in the Example of the present disclosure.

### DETAILED DESCRIPTION

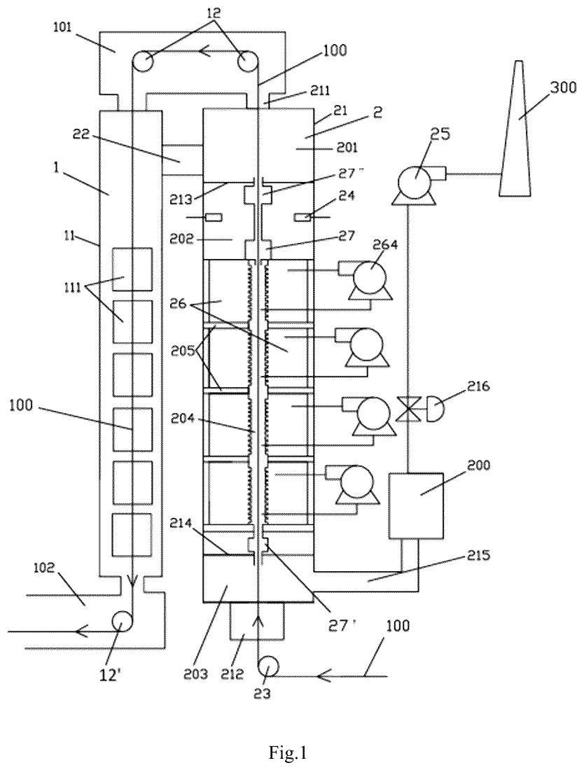

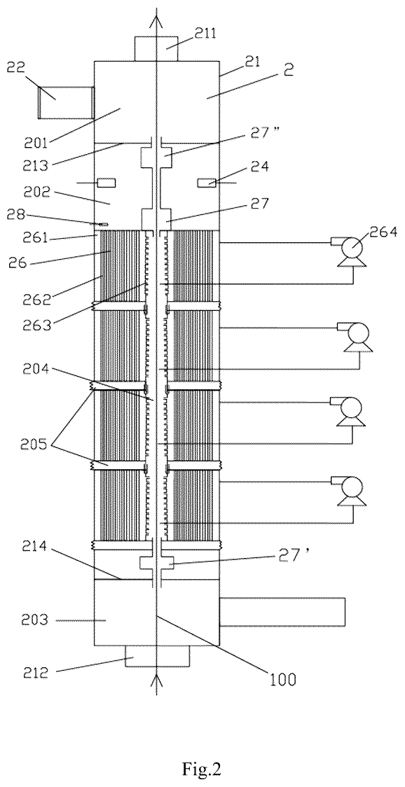

Referring to FIG. 1, FIG. 2, the jet direct fire preheating system of the present disclosure comprises: a direct fire furnace 1, a preheating furnace 2; wherein the direct fire furnace 1 comprises:
a furnace shell 11, wherein a furnace top roller chamber 101 and a furnace bottom roller chamber 102 are respectively provided at the upper and lower ends; steering rollers 12 and 12′are respectively arranged in the furnace top roller chamber 101 and the furnace bottom roller chamber 102; a plurality of direct fire heating zones 111 are arranged in the furnace shell 11 along the height direction, and a plurality of direct fire burners are arranged in the direct-fire heating zone 111; two through-holes are provided on the upper side wall of the furnace shell 11, and are symmetrically arranged on the left and right;
the preheating furnace 2 comprises:
a furnace body 21, which is provided with at least two connecting holes on the upper side wall, symmetrically arranged on the left and right, wherein the connecting holes connect through holes of the upper part of the furnace shell 11 of the direct fire furnace 1 through a communicating pipe 22 respectively; wherein the top of the furnace body 21 is provided with a furnace throat 211 corresponding to the top roller chamber 101 of the direct fire furnace 1 for passing the strip steel; the bottom of the furnace body 21 is provided with a strip steel inlet and a corresponding sealing device 212 and a steering roller 23; the upper part of the furnace body 21 is provided with an upper partition plate 213 with a threading hole to form an upper gas collection chamber 201 of direct fire exhaust gas; a secondary combustion chamber 202 for direct fire combustion exhaust gas is provided below the upper gas collection chamber 201 of direct fire exhaust gas, and at least one open flame burner 24 is provided in the secondary combustion chamber 202 for direct fire combustion exhaust gas; the lower part of the furnace body 21 is provided with a lower partition plate 214 with a threading hole to form a lower gas collection chamber 203 of direct fire exhaust gas, which connects an exhaust gas fan 25 through an exhaust gas discharge pipeline 215;
a plurality of heat exchange and jet bellows units 26, which are arranged on two sides below the secondary combustion chamber 202 for direct fire combustion exhaust gas in the furnace body 21 along the height direction of the furnace body 21, wherein a threading channel 204 for passing the strip steel is formed in the middle; wherein each heat exchanger and jet bellows unit 26 comprises,
a bellows body 261, which is vertically provided with a plurality of heat exchange pipes 262, wherein the bellows body 261 is provided with a plurality of nozzles 263 on the side opposite to the threading channel 204; wherein an exhaust gas secondary mixing chamber 205 that is communicated with the heat exchange pipe 262 is provided between the bellows bodies 261 that are arranged up and down; a shielding gas of nitrogen and hydrogen is introduced into the bellows body 261;
a circulating fan 264, wherein an inlet pipeline port is arranged in the threading channel 204, and an outlet pipeline port is located in the bellows body 261;
a plurality of sealing devices 27, 27′, 27″ that can be passed through by the strip steel are respectively arranged at the upper and lower ports of the threading channel 204 and the threading holes of the upper and lower partition plates 213, 214.

Preferably, a combustion exhaust gas thermometer 28 is further provided in the secondary combustion chamber 202 for direct fire combustion exhaust gas

Preferably, the sealing devices 27, 27′, 27″ have a nitrogen gas sealing structure, which adopts a nitrogen gas sealing chamber with a nitrogen gas injection pipeline arranged thereon.

Preferably, a control valve 216 is arranged on the exhaust gas discharge pipeline 215.

The strip steel 100 is turned upwards by the front steering roller of the direct fire furnace. It first enters the preheating furnace 2 for preheating after being sealed by the sealing device at the preheating furnace inlet, then enters the top roller chamber of the direct fire furnace 1, enters the direct fire furnace 1 for direct fire heating after being turned by the steering roller, then enters the bottom roller chamber of the direct fire furnace 1, and continues to run after being turned by the steering roller.

After the shielding gas of nitrogen and hydrogen is heated by the direct fire combustion exhaust gas through the heat exchange pipeline, the temperature of the exhaust gas decreases (the shielding gas of nitrogen and hydrogen is sprayed to the upper and lower surface of the strip steel under the action of the circulating fan to preheat the strip steel). The cooled shielding gas of nitrogen and hydrogen is sucked into the bellows by the circulating fan 264 on both of the working side (WS side) and the driving side (DS side) of the preheating furnace for heat exchange with the heat exchange pipeline. The direct fire combustion exhaust gas passes through the heat exchange and jet bellows units from top to bottom in sequence, and under the suction of the frequency conversion exhaust gas fan 25, through the exhaust gas discharge pipeline 215, it first passes through the waste heat boiler 200 for the secondary utilization of the waste heat of combustion exhaust gas outside the furnace, and then enters the chimney 300 for the final discharge.

Referring to FIG. 2, before the jet gas heat exchange, the high-temperature combustion exhaust gas is heat exchanged with the strip steel 100 in the upper gas collection chamber 201 for direct fire exhaust gas (i.e., ordinary high temperature preheating). The high-temperature combustion exhaust gas of direct fire combustion enters the secondary combustion chamber 202 for direct fire combustion exhaust gas after heat exchange and cooling with the strip steel, and the inside of the secondary combustion chamber 202 for direct fire combustion exhaust gas (the part close to the strip steel) is provided with sealing devices 27, 27″—nitrogen sealing chambers, which connect the nitrogen gas injection pipeline for injecting nitrogen at a certain pressure, of which the purpose is to reduce the direct fire combustion exhaust gas (including the gas that is not fully combusted) entering the threading channel 204 in the lower part as much as possible. From the secondary combustion chamber 202 for direct fire combustion exhaust gas, the direct fire combustion exhaust gas no longer directly contacts the strip steel 100.

The direct fire exhaust gas coming from the exhaust gas secondary combustion chamber 202 continues to flow downward through the heat exchange pipe 262. As mentioned above, the circulating injected shielding gas of nitrogen and hydrogen is heated through heat exchange in the flow process, then enters the exhaust gas secondary mixing chamber 205 between the jet bellows bodies for homogenization of the exhaust gas temperature in the exhaust gas secondary mixing chamber 205, and then enters the downward heat exchange and jet bellows unit until it reaches the lower gas collection chamber 203 for direct fire exhaust gas at the bottom, and contacts the strip steel for mild heat exchange.

In the whole structure of the preheating system, from the nitrogen sealing device at the top of the preheating furnace to the nitrogen sealing device at the bottom of the preheating furnace, the strip steel is not in direct contact with the combustion exhaust gas. Until the jet heat exchange is carried out, the exhaust gas in the exhaust gas collection chamber for direct fire combustion exhaust gas is in contact with the strip steel again to undergo mild heat exchange. Because the strip steel is at room temperature at this moment, the influence of the oxidability of the exhaust gas on the surface of the strip steel has been negligible.

The above embodiments are only illustrative and are not intended to limit the scope of the present disclosure. The technical solution derived from the inventive concept of the present disclosure is also within the protection scope of the present disclosure.

1. A preheating furnace, which comprises:
a furnace body, which is provided with at least two connecting holes on the upper side wall, symmetrically arranged on the left and right, wherein the connecting holes connect through holes of the upper part of the furnace shell of the direct fire furnace through a communicating pipe respectively; wherein the top of the furnace body is provided with a furnace throat corresponding to a furnace top roller chamber of a direct fire furnace for passing the strip steel; the bottom of the furnace body is provided with a strip steel inlet and a corresponding sealing device and a steering roller; the upper part of the furnace body is provided with an upper partition plate with a threading hole to form an upper gas collection chamber for direct fire exhaust gas; a secondary combustion chamber for direct fire combustion exhaust gas is provided below the upper gas collection chamber for direct fire exhaust gas, and at least one open flame burner is provided in the secondary combustion chamber for direct fire combustion exhaust gas; the lower part of the furnace body is provided with a lower partition plate with a threading hole to form a lower gas collection chamber for direct fire exhaust gas, which connects an exhaust gas fan through an exhaust gas discharge pipeline;
a plurality of heat exchange and jet bellows units, which are arranged on two sides below the secondary combustion chamber for direct fire combustion exhaust gas in the furnace body along the height direction of the furnace body, wherein a threading channel for passing the strip steel is formed in the middle; wherein each heat exchanger and jet bellows unit comprises,
a bellows body, which is vertically provided with a plurality of heat exchange pipes, wherein the bellows body is provided with a plurality of nozzles on the side opposite to the threading channel; wherein an exhaust gas secondary mixing chamber that is communicated with the heat exchange pipe is provided between the bellows bodies that are arranged up and down;
a circulating fan, wherein an inlet pipeline port is arranged in the threading channel, and an outlet pipeline port is located in the bellows body;
a plurality of sealing devices that can be passed through by the strip steel are respectively arranged at the upper and lower ports of the threading channel and the threading holes of the upper and lower partition plates.

2. The preheating furnace according to claim 1, wherein a combustion exhaust gas thermometer is further provided in the secondary combustion chamber for direct fire combustion exhaust gas.

3. The preheating furnace according to claim 1, wherein the sealing device is a nitrogen gas sealing structure, which adopts a nitrogen gas sealing chamber with a nitrogen gas injection pipeline arranged thereon.

4. The preheating furnace according to claim 1, wherein the exhaust gas discharge pipeline is connected to a waste heat boiler and a chimney.

5. The preheating furnace according to claim wherein a control valve is arranged on the exhaust gas discharge pipeline.

6. The preheating furnace according to claim 1, wherein a shielding gas of nitrogen and hydrogen is introduced into the bellows body.

7. A jet direct fire preheating system, which comprises: a direct fire furnace, a preheating furnace; wherein
the direct fire furnace comprises:
a furnace shell, wherein a furnace top roller chamber and a furnace bottom roller chamber are respectively provided at the upper and lower ends; steering rollers are respectively arranged in the furnace top roller chamber and the furnace bottom roller chamber; a plurality of direct fire heating zones are arranged in the furnace shell along the height direction, and a plurality of direct fire burners are arranged in the direct-fire heating zone; at least two through-holes are provided on the upper side wall of the furnace shell, and are symmetrically arranged on the left and right;
the preheating furnace comprises:
a furnace body, which is provided with at least two connecting holes on the upper side wall, symmetrically arranged on the left and right, wherein the connecting holes connect through holes of the upper part of the furnace shell of the direct fire furnace through a communicating pipe respectively; wherein the top of the furnace body is provided with a furnace throat corresponding to the furnace top roller chamber of the direct fire furnace for passing the strip steel; the bottom of the furnace body is provided with a strip steel inlet and a corresponding sealing device and a steering roller; the upper part of the furnace body is provided with an upper partition plate with a threading hole to form an upper gas collection chamber for direct fire exhaust gas; a secondary combustion chamber for direct fire combustion exhaust gas is provided below the upper gas collection chamber for direct fire exhaust gas, and at least one open flame burner is provided in the secondary combustion chamber for direct fire combustion exhaust gas; the lower part of the furnace body is provided with a lower partition plate with a threading hole to form a lower gas collection chamber for direct fire exhaust gas, which connects an exhaust gas fan through an exhaust gas discharge pipeline;
a plurality of heat exchange and jet bellows units, which are arranged on two sides below the secondary combustion chamber for direct fire combustion exhaust gas in the furnace body along the height direction of the furnace body, wherein a threading channel for passing the strip steel is formed in the middle; wherein each heat exchanger and jet bellows unit comprises,
a bellows body, which is vertically provided with a plurality of heat exchange pipes, wherein the bellows body is provided with a plurality of nozzles on the side opposite to the threading channel; wherein an exhaust gas secondary mixing chamber that is communicated with the heat exchange pipe is provided between the bellows bodies that are arranged up and down;
a circulating fan, wherein an inlet pipeline port is arranged in the threading channel, and an outlet pipeline port is located in the bellows body;
a plurality of sealing devices that can be passed through by the strip steel are respectively arranged at the upper and lower ports of the threading channel and the threading holes of the upper and lower partition plates.

8. The jet direct fire preheating system according to claim 7, wherein a combustion exhaust gas thermometer is further provided in the secondary combustion chamber for direct fire combustion exhaust gas.

9. The jet direct fire preheating system according to claim 7, wherein the sealing device is a nitrogen gas sealing structure, which adopts a nitrogen gas sealing chamber with a nitrogen gas injection pipeline arranged thereon.

10. The jet direct fire preheating system according to claim 7, wherein the exhaust gas discharge pipeline is connected to a waste heat boiler and a chimney.

11. The jet direct fire preheating system according to claim wherein a control valve is arranged on the exhaust gas discharge pipeline.

12. The jet direct fire preheating system according to claim 7, wherein a shielding gas of nitrogen and hydrogen is introduced into the bellows body.

13. The preheating furnace according to claim 4, wherein a control valve is arranged on the exhaust gas discharge pipeline.

14. The jet direct fire preheating system according to claim 10, wherein a control valve is arranged on the exhaust gas discharge pipeline.
